(19) United States
(12) Patent Application Publication
(10) Pub. No.: US 2011/0238310 A1
(43) Pub. Date: Sep. 29, 2011

(54) FRY CYCLE MONITORING

(75) Inventors: ARIES ESTRELLADO, St. Paul, MN (US); MICHAEL J. ZWEBER, Burnsville, MN (US); MATT JENNINGS, HAM LAKE, MN (US)

(73) Assignee: RESTAURANT TECHNOLOGIES, INC., EAGAN, MN (US)

(21) Appl. No.: 12/893,372

(22) Filed: Sep. 29, 2010

Related U.S. Application Data
(63) Continuation-in-part of application No. 12/060,705, filed on Apr. 1, 2008.

(51) Int. Cl. G06F 19/00

(52) U.S. Cl. 702/1

(57) ABSTRACT

A method comprises operating one or more commercial fryers, including activating an operational event for the one or more commercial fryers by sending a current through a wire to an operational member of the commercial fryer, collecting information each time a different operational event is carried out in the commercial fryer by sensing whether the current is flowing through the wire or by sensing whether a voltage is present in the wire, and communicating the information to a database.

### RELATED APPLICATION

This application is a continuation-in-part of U.S. patent application Ser. No. 12/060,705, filed Apr. 1, 2008, which is incorporated herein by reference.

### FIELD OF THE INVENTION

The present disclosure relates to a system and method for tracking data for commercial fryers. More particularly, the disclosure relates to a system and method for tracking fry cycle events and filtration events in commercial fryers.

### BACKGROUND

Commercial fryers are commonly used in restaurants to prepare food. Optimizing fried food production is a multi-level process involving several technologies and considerations. Heating methods, filtration, temperature control, oil circulation, oil quality as well as the specific food and coating being fried affect the overall quality and consistency of the finished product.

It is generally considered that, in any frying system, the most important factor to end-product quality is the frying oil itself. The oil transfers thermal energy from the fryer's heating unit to the food surface. It is also an ingredient, as the product picks up 10-12% oil during the frying process. Browning, crisping, and dehydration of the food's exterior surface or coating occur while its interior heats and/or cooks through conduction.

Many restaurants that use such fryers use fryer oil operating procedures for quality control of the flying oil, and thus, of the finished product. Filtration of the fryer oil is a significant aspect of this operating procedure. Filtration of fryer oil is often carried out on the basis of the number of fry cycles that have occurred. A fry cycle is the completed preparation of a batch of food. Generally, a fry cycle begins with an operator filling a fryer basket with a batch of uncooked food. The fryer basket is then lowered into a heated fryer oil reservoir and the food is cooked in the fryer oil for a predetermined amount of time. Removal of the fryer basket from the oil reservoir after the predetermined cooking time has expired concludes the fry cycle. Filtration of fryer oil on the basis of number of fry cycles thus comprises filtering the fryer oil after a certain number of fry cycles have been completed. For example, some restaurants require that oil is filtered after every three fryer cycles.

Proper filtering of fryer oil helps ensure fryer oil quality. Such quality in turn maintains consistent food quality and lengthens the oil life. Keeping fryer oils clean via filtration extends the useable life of the fryer oils and positively contributes to the taste, texture and overall quality of the food. Filtration of the oil can address issues such as solid impurities as well as chemical, or soluble, contaminants that can be major causes of oil breakdown. Thus, generally, filtration can minimize off-flavors, colors, odors and food debris from frying oil.

Frequently, a fryer's cooking oil is filtered by means of a built-in filtration system. Currently, however, most fryers possess no resident intelligence to denote that filtration of the oil (“a filtration event”) has occurred. That is, aside from a visual validation, currently, there is no efficient means to determine if fryer oil filtration has taken place.

### BRIEF SUMMARY

A system and method for tracking operating data for commercial fryers is provided. More particularly, a system and method for tracking fry cycle events and filtration events in commercial fryers is provided.

In one embodiment, a method comprises operating one or more commercial fryers, including activating an operational event for the one or more commercial fryers by sending a current through a wire to an operational member of the commercial fryer, collecting information each time a different operational event is carried out in the commercial fryer by sensing whether the current is flowing through the wire or by sensing whether a voltage is present in the wire, and communicating the information to a database.

In a further embodiment, a commercial fryer tracking system includes one or more commercial fryers including an oil filtration mechanism and a fry cycle mechanism; a first sensor operatively coupled to a wire supplying current to the oil filtration mechanism, the first sensor adapted to either sense a current through the wire or sense a voltage present in the wire, and deliver a signal indicative of an operational event of the oil filtration mechanism; a second sensor operatively coupled to a wire supplying current to the fry cycle mechanism, the second sensor adapted to sense a current through the wire or sense a voltage present in the wire, and deliver a signal indicative of an operational event of the fry cycle mechanism; at least one control box, the control box being operatively associated with the first and second sensors such that control box receives operational information of the commercial fryer; and a database for storing the operational information, the database being in communication with the control box such that the control box sends information regarding counted operation events to the database.

While multiple embodiments are disclosed, still other embodiments will become apparent to those skilled in the art from the following detailed description, which shows and describes illustrative embodiments of the invention. As will be realized, the system and method are capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a block diagram depicting a commercial fryer operating data tracking system in accordance with one embodiment of the present disclosure.

FIG. 2 is a block diagram depicting a commercial fryer operating data tracking system in accordance with one embodiment of the present disclosure.

FIG. 3 is a block diagram depicting a commercial fryer operating data tracking system in accordance with one embodiment of the present disclosure.

FIG. 4 is a flow diagram illustrating the tracking of commercial fryer operating information in accordance with one embodiment of the present disclosure.

FIG. 5 is a block diagram depicting a commercial fryer operating data tracking system in accordance with one embodiment of the present disclosure.

### DETAILED DESCRIPTION

### A. Overview

The present disclosure relates to a system and method for tracking operating data for commercial fryers. The system and method of the present invention may be used by any user of a fryer to optimize the maintenance of fryer oil. Optimizing maintenance of fryer oil ensures quality of the fryer oil and, in turn, quality of the final product.

In one embodiment, the system and method includes counting and tracking operational events of commercial fryers such as filtration events and fry cycle events. On the basis of this information, the system and method may generate reports detailing, for example, the number of fry cycle events occurring per filtration event. Such reports may be used by the user of the fryer, for example a restaurant, to identify possible issues with quality control of the fryer oil. For example, if a restaurant filters cooking oil once per ten fry cycles, the system and method allows for automated calculation of this statistic and thus enables restaurants to easily identify a possible maintenance issue and take appropriate actions.

### B. System Configuration

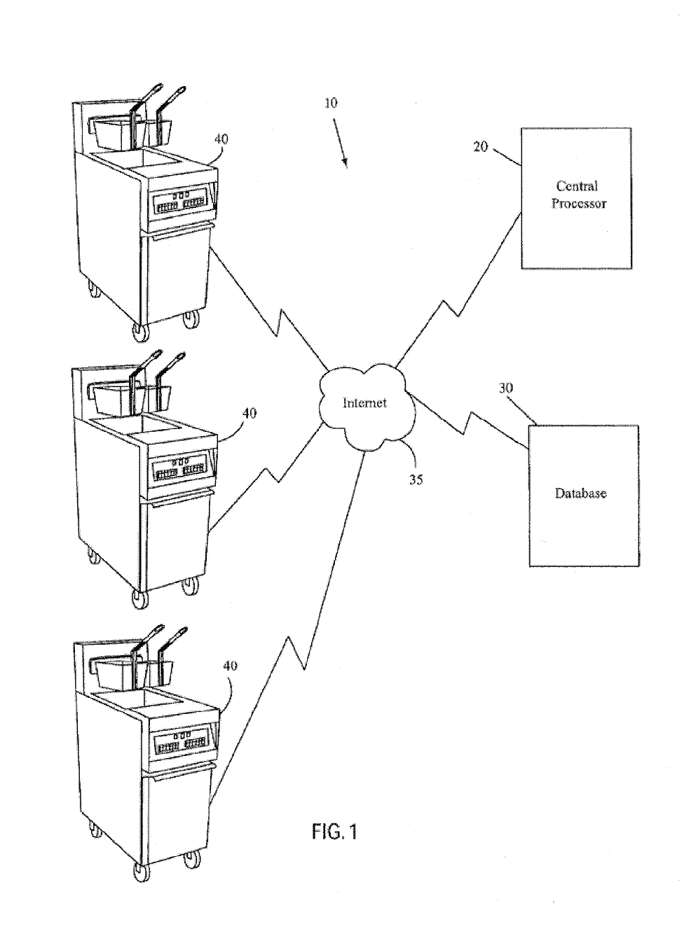

As shown in FIG. 1, the present disclosure in some embodiments relates to an equipment monitoring system 10. In one embodiment, the system 10 may comprise a central processor 20 located at a central location, one or more databases 30 to store system data, and a plurality of commercial fryers 40 located at a plurality of remote locations, each equipped with means to communicate with the central processor 20 and database 30 over the internet 35 or other telecommunications network. The commercial fryers 40 may be located at different locations, at the same location, or a mix thereof. While the system is described with respect to an embodiment wherein the central processor 20 is at a location remote from the commercial fryers 40, it is to be appreciated that the central processor 20 may alternatively be provided at the location of the commercial fryers 40.

The central processor 20 can be any computer or processor known to those skilled in the art, including standard attachments and components thereof (e.g., a disk drive, hard drive, CD player or network server that communicates with a central processing unit (CPU) and main memory, a sound board, a keyboard, a mouse, a monitor, and/or other component).

The central processor 20 includes software programs or instructions that process requests and responses from a user of the monitoring system 10. These software programs or instructions send information to and receive information from the database 30, perform compilation and storage functions, and generate reports that may be used by users of the system 10. The software may be software applications commercially sold and normally used by those skilled in the art or may be specific applications coded for use with the system disclosed herein.

The system 10 may also include one or more databases 30 for storing system data. The database may be any means for storing information and may generally be of any type generally known in the art. In one embodiment, the databases 30 may be integral to the central processor 20. In an alternative embodiment, the databases 30 may be accessible to the central processor through a computer network or other suitable communication link. In one embodiment, the database 30 is comprised of a plurality of database servers, some of which are integral to the central processor 20, and some of which are located remotely from the central processor 20.

In some embodiments, the database 30 includes information relating to operation of fryers from one or more sites of a restaurant. For the purposes of this description, the term “restaurant” may refer to an entity having a single site or an entity having a plurality of sites. The fryer information may include site information, relating to all sites where a restaurant has fryers, including site location, identification of fryers at the site, and other relevant site information. As will be discussed in greater detail below, in some embodiments, the database 30 includes fryer operating statistics.

As shown, the system 10 may include one or more commercial fryers 40. Commercial fryers 40 may comprise any device known in the art for the preparation of food or consumables by means of heated cooking oil. Generally, any means for frying a consumable may be used.

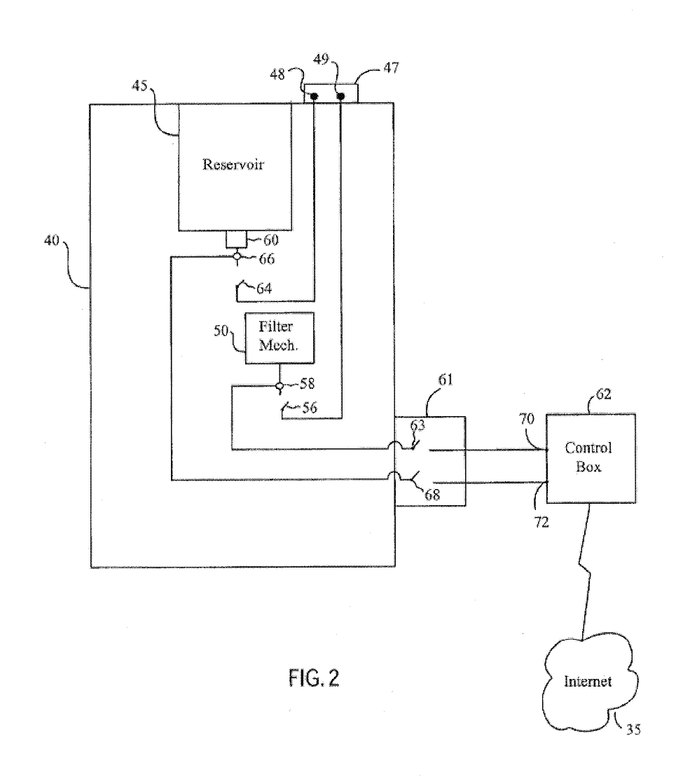

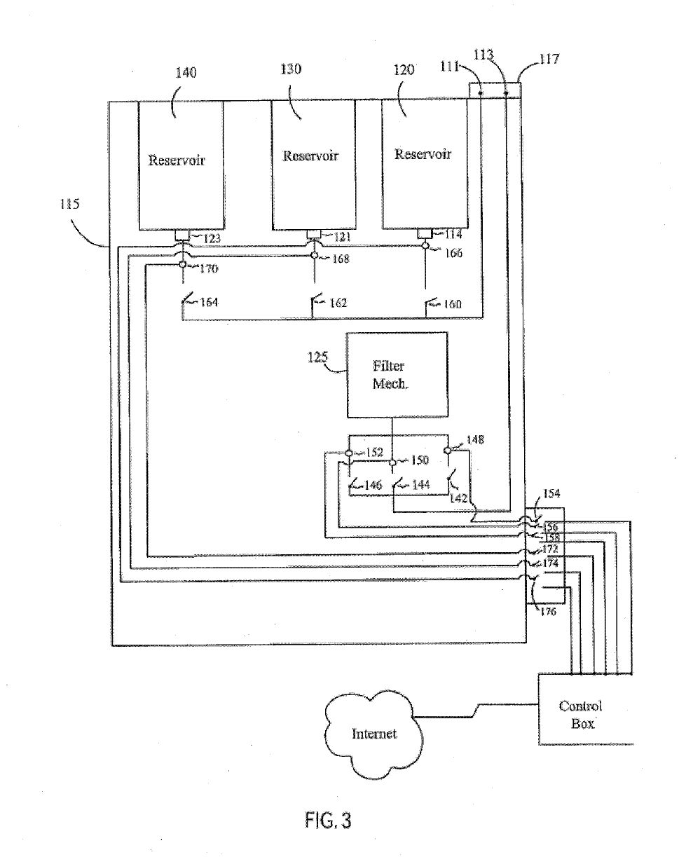

FIG. 2 illustrates a commercial fryer 40 such as may be used with the system and method. In one embodiment, commercial fryer 40 comprises a fryer having a single oil reservoir 45 and user interface 47. In alternative embodiments, a plurality of oil reservoirs may be provided (see, for example, FIG. 3). A filtering mechanism 50 and fry cycle mechanism 60 may be associated with the commercial fryer 40.

The user interface 47 may comprise a display for showing information relating to the operation of fryer 40 and/or actuators for initiating or effecting operations within fryer 40. In one embodiment, user interface 47 comprises a fry cycle actuator 48 and a filter actuator 49. Any type of actuation mechanism may be used. For example, push button actuators may be used.

Filtering mechanism 50 may comprise any device for removing debris from cooking oil such as those standardly available for use with commercial fryers. For example, in one embodiment, filtering mechanism 50 may comprise a motor-driven pump in fluid communication with the fryer oil reservoir 45 which pushes oil back to the oil reservoir 45 after the oil has been drawn from the oil reservoir 45 to the filtering mechanism 50 by gravity.

In some embodiments, tracking of filtration of events may be achieved through operation of electronic components coupled to the filtering mechanism 50. For example, in one embodiment, a filter pump switch 56, transducer 58, relay 63, and control box 62 are in electronic communication with the filter actuator 49 and filtering mechanism 50. Filter pump switch 56 and transducer 58 may comprise any such standard components found in commercial fryers. Relay 63, in some embodiments, is provided in a relay box 61 which may be operatively associated with the fryer. In one embodiment, the relay box 61 is coupled to an external surface of fryer 40. Relay 63 may comprise any standard relay used by those skilled in the art.

In some embodiments, control box 62 provides a communication link between the fryer 40 and database 30 or central processor 20. Communication technology, such as a cellular modem, any other wireless communication system, and/or a landline communication system may be used to form a communication link between the control box 62 and database 30 or central processor 20.

Control box 62 may comprise any device or means capable of counting and telecommunications. In some embodiments, the control box 62 may be capable of counting and communicating in real time. A suitable control box 62 for use with the system and method is an iBoard® manufactured by Control Solutions, Inc., of White Bear Lake, Minn. In some embodiments, control box 62 includes a plurality of inputs for receiving signals regarding operation of the fryer or filter, such as triggering of a filtration event or a fry cycle event. For example, in one embodiment, control box 62 includes inputs 70, 72. Thus, as is described more fully below, the control box 62 may be used to perform a count of operational events of the fryer, such as filtration events or fry cycle events. This may be referred to as establishing an event count.

In some embodiments, a sequence of operation of the filter pump switch 56, transducer 58, relay 63, and control box 62 for tracking filtration events is as follows. Actuation of the filter actuator 49 initiates the sequence. Actuation may be manual actuation by an operator, automated actuation, or other. In response to actuation of the filter actuator 49, an actuation signal from the circuit for closing filter pump switch 56 is generated, thereby closing switch 56 and causing current to be supplied to the filtering mechanism 50. The transducer 58 senses the current and generates a signal which is received by relay 63, thereby actuating relay 63, Once actuated, the relay 63 emits a signal which is received by a control box input 70 and recorded by control box 62. This signal may be used to set an event count.

In some embodiments, the fryer 40 may further comprise a fry cycle mechanism 60. For example, in one embodiment, fry cycle mechanism 60 may comprise a standard electromechanical valve, or solenoid valve, found in commercial fryers, which regulates the flow of fryer oil to and from the oil reservoir. The solenoid valve may be opened/closed by running/stopping an electrical current through the valve.

Tracking of fry cycle events may be achieved in much the same way as tracking of filtration events. Thus, a sequence of operation of the fry cycle switch 64, transducer 66, relay 68 and control box 62 for tracking fry cycle events is as follows. The fry cycle switch 64, transducer 66, relay 68, and the control box 62 are in electronic communication with the fry cycle actuator 48 and fry cycle mechanism 60. Actuation of the fry cycle actuator 48 initiates the sequence. Actuation may be manual actuation by an operator, automated actuation, or other. In response to actuation of the fry cycle actuator 48, an actuation signal from the circuit for closing the fry cycle switch 64 is generated, thereby closing the switch 64 and causing current to be supplied to the fry cycle mechanism 60. The transducer 66 senses the current and generates a signal which is received by relay 68, thereby actuating relay 68. Once actuated, the relay 68 emits a signal which is received by control box input 72 and recorded by control box 62. This signal may be used to set an event count.

FIG. 3 illustrates an alternative embodiment of a commercial fryer 115 having a plurality of reservoirs. In the embodiment of FIG. 3, fryer 115 comprises fryer reservoirs 120, 130, and 140. It should be appreciated, however, that the system and method may be used with fryers having any number of fryer reservoirs.

In some embodiments, fryer 115 further comprises a user interface 117 which may comprise a display for showing information relating to the operation of fryer 115 and/or actuators for initiating or effecting operations within fryer 115. In one embodiment, the user interface 117 includes a fry cycle actuator 111 and filtration actuator 113, a fry cycle mechanisms for each reservoir (119, 121, 123) and a filter mechanism 125. In some embodiments, a single fry cycle mechanism may be used for all of the reservoirs. Any type of actuation mechanism may be used. For example, push button actuators may be used. In one embodiment, and as is conventional, user interface 117 may further comprise display means which allow an operator to select between fryer reservoirs 120, 130, and 140.

Tracking of fry cycle events and filtration events for the commercial fryer 115 may be carried out using substantially similar components to that of previous embodiments such as described with respect to FIG. 2. That is, the user interface 117 and fry cycle mechanisms (119, 121, 123) or filter mechanism 125 may be in electronic communication with filter pump switches (142, 144, 146), transducers (148, 150, 152), relays (154, 156, 158), fry cycle switches (160, 162, 164), transducers (166, 168, 170), relays (172, 174, 176) and control box 178. Such communication can produce a count of fry cycle events or filtration events at the control box 178. Thus, using the system of FIG. 3, filtration events and fry cycle events for each reservoir 119, 121, 123 may be counted in substantially the same way as counting of filtration events and fry cycle events of reservoir 45 of FIG. 2.

### C. Fryer Data Tracking

The present disclosure relates to a system and method for tracking operating data from commercial fryers. In one embodiment, the system and method includes tracking filtration events and fry cycle events in commercial fryers. As described, FIGS. 2 and 3 illustrate fryers including components for counting or racking filtration events and fry cycle events.

Prior to implementation of the system and method, or as part of implementation of the system and method, some or all of a restaurant's fryers may be inventoried and an identifier created for each fryer to give it a trackable identity. Additionally, in some embodiments, types of data to be monitored may be created to enable a determination of information to be stored, and to enable differentiation of operating information. In some embodiments, data to be stored includes any information relating to operation of a fryer. In one embodiment, the operational information to be stored includes any or all of fry cycle event count, date/time associated with each fry cycle event, filtration event count, and date/time associated with each filtration event.

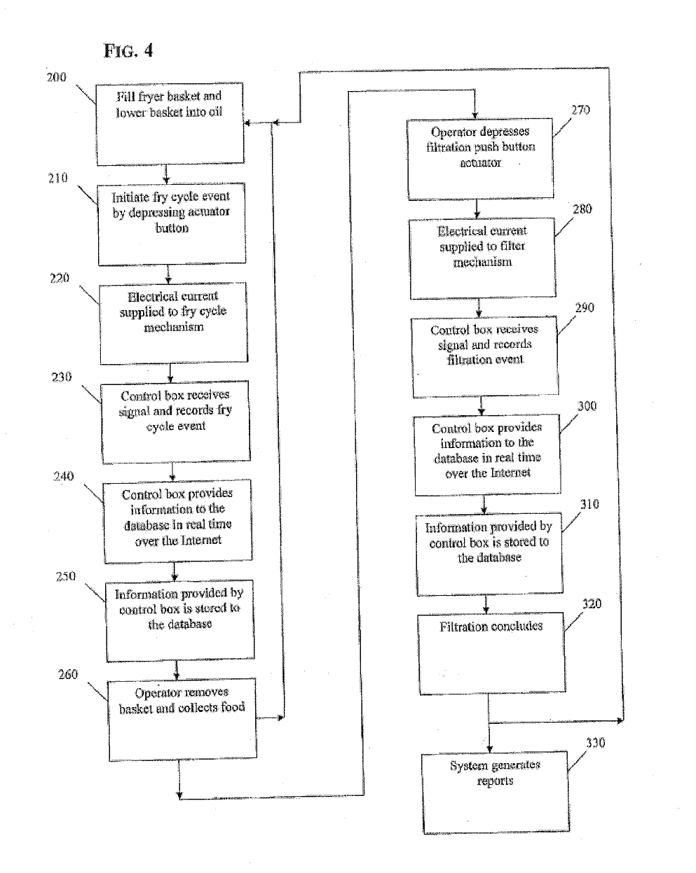

FIG. 4 is a flow chart illustrating the tracking of operating data from a restaurant's fryers 40 in accordance with one embodiment. An operator fills a fryer basket with a batch of uncooked food and at least partially immerses the basket in the fryer oil reservoir (block 200). The operator then initiates a fry cycle event by actuating the fryer cycle actuator associated with the selected fryer oil reservoir (block 210), thereby causing electrical current to flow to the fry cycle mechanism 60 (block 220). As described in detail above, the control box 62 then receives an electronic signal indicating that a fry cycle event has occurred in the selected fryer oil reservoir (block 230). The control box 62 then provides information to the database 30 (block 240). Provision of such information may be in real time or may, in some embodiments, be delayed, such as reporting of occurred events on a timed basis. In some embodiments, the control box provides any information relating to the fry cycle event. In one embodiment, the control box 62 provides either or both of the fry cycle event count (for example, indicating that +1 fry cycle event has occurred) and the date/time of the fry cycle event. The information provided by the control box 62 may then be stored to the database 30 (block 250) and associated with the fryer reservoir for which information was provided by the control box 62. In some embodiments, the system saves all such fry cycle event information in the database 30 such that the system accumulates all fry cycle event history. After a predetermined cook time, the operator removes the fryer basket from the oil reservoir and collects the cooked food (block 260).

The process outlined above may be repeated any number of times before an operator initiates a filtration event (block 270) by actuating the filtration actuator associated with a selected fryer reservoir, thereby causing electrical current to flow to the filtering mechanism 50 (block 280). As described above, the control box 62 then receives an electronic signal indicating that a filtration event has occurred in the selected fryer reservoir (block 290). The control box 62 then provides information to the database 30 (block 300). Provision of such information may be in real time or may, in some embodiments, be delayed, such as reporting of occurred events on a timed basis. In some embodiments, the control box provides any information relating to the filtration event. In one embodiment, the control box 62 provides either or both of the filtration event count (for example, indicating that +1 filtration event has occurred) and the date/time of the filtration event. The information provided by the control box 62 may then be stored to the database 30 (block 310) and associated with the fryer reservoir for which information was provided by the control box 62. In some embodiments, the system saves all such filtration event information in the database 30 such that the system accumulates all filtration event history. After the filtration event has concluded (block 320) an operator may again initiate a fry cycle (block 200).

It is to be appreciated that while reference is made to saving all fry cycle event and/or filtration event information to accumulate all fry cycle event history and filtration event history, a user may choose to delete information or to save less information. For example, in some embodiments, the system may be configured to delete information after it has been stored for a certain amount of time, such as on a weekly basis.

On the basis of the stored fry cycle event data and the stored filtration event data, the system 10 may generate fryer operation reports (block 330). For example, in one embodiment, a user of the system 10 accesses the central processor 20 and prompts the system 10 to generate a fryer operation report. In some embodiments, fryer operation reports may be generated for any number of fryers. For example, in one embodiment, a user may prompt the system 10 to generate operation reports for all of a restaurant's fryers. In an alternative embodiment, a user may prompt the system 10 to generate operation reports for only those fryers selected by the user. It should be appreciated that the system 10 may be prompted to generate reports for any number of fryers at any number of restaurants. Further, the system may be configured to automatically generate reports after a certain number of fry cycle events have occurred, after a certain number of filtration events have occurred, or on a timed (for example, weekly) basis.

In some embodiments, fryer operation reports may comprise any information relating to the operation of fryers. In one embodiment, the operation reports may comprise operating statistics. For example, in one embodiment, the operation reports may comprise either or both of the fry cycle event count and filtration event count for selected fryers or fryer reservoirs over a given period. In an alternative embodiment, the operation reports may comprise the filter to fry ratio for a selected fryer or selected fryer reservoirs over a given period. For example, the filter to fry ratio may be calculated using the following equation:

$$\frac{[ \# of fry cycle events for given period ]}{[ \# of filtration events for given period ]}$$

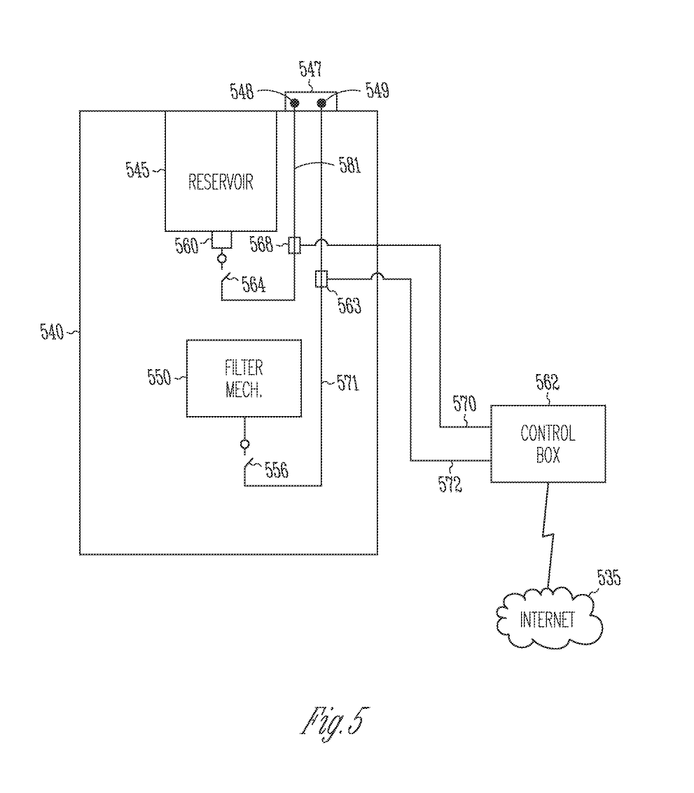

FIG. 5 illustrates a commercial fryer 540 such as may be used with the system and method. In one embodiment, commercial fryer 540 comprises a fryer having a single oil reservoir 545 and user interface 547. In alternative embodiments, a plurality of oil reservoirs may be provided (see, for example, FIG. 3). Operational members such as a filtering mechanism 550 and fry cycle mechanism 560 may be associated with the commercial fryer 540.

The user interface 547 may comprise a display for showing information relating to the operation of fryer 540 and/or actuators for initiating or effecting operations within fryer 540. In one embodiment, user interface 547 comprises a fry cycle actuator 548 and a filter actuator 549. Any type of actuation mechanism may be used. For example, push button actuators may be used.

Filtering mechanism 550 may comprise any device for removing debris from cooking oil such as those standardly available for use with commercial fryers. For example, in one embodiment, filtering mechanism 550 may comprise a motor-driven pump in fluid communication with the fryer oil reservoir 545 which pushes oil back to the oil reservoir 545 after the oil has been drawn from the oil reservoir 545 to the filtering mechanism 550 by gravity.

In some embodiments, collecting information related to operational events of the commercial fryer 540, such as tracking of filtration of events, and the date/time associated with a filtration event, and/or the duration of the filtration event, may be achieved through operation of electronic components coupled to the filtering mechanism 550. For example, in one embodiment, a filter pump switch 556, a sensor 563, and control box 562 are in electronic communication with the filter actuator 549 and filtering mechanism 550. In one embodiment, sensor 563 can include an amp clamp type ammeter. An amp clamp does not require that there be a physical tie-in to the electrical circuit for the filtering mechanism. Instead, the amp clamp 563 wraps around the wire 571 and senses the current flowing through the wire. This allows the system to know every time the filtering mechanism 550 is turned on. In one embodiment, sensor 563 can include a voltage detector, such as a capacitive coupling device. The voltage detector can be a non-contact device that can sense voltage without tapping into the wire and can be used to sense whether a voltage is present in wire 571 and thus whether a filtration event has begun or ended.

In some embodiments, control box 562 provides a communication link between the fryer 540 and database 530 or central processor 520. Communication technology, such as a cellular modem, any other wireless communication system, and/or a landline communication system may be used to form a communication link between the control box 562 and database 530 or central processor 520.

Control box 562 may comprise any device or means capable of receiving operational information, such as event counting, and telecommunications. In some embodiments, the control box 562 may be capable of counting and communicating in real time. A suitable control box 562 for use with the system and method is an iBoard® manufactured by Control Solutions, Inc., of White Bear Lake, Minn. In some embodiments, control box 562 includes a plurality of inputs for receiving signals regarding operation of the fryer or filter, such as triggering of a filtration event or a fry cycle event, or the date/time associated with the events. For example, in one embodiment, control box 562 includes inputs 570, 572. Thus, the control box 562 may be used to perform a count of operational events of the fryer, such as filtration events or fry cycle events. This may be referred to as establishing an event count. The control box 562 may further receive information for determining the duration of the filtration event or the fry cycle.

In some embodiments, a sequence of operation of the filter pump switch 556, sensor 563, and control box 562 for tracking filtration events or other filtration information is as follows. Actuation of the filter actuator 549 initiates the sequence. Actuation may be manual actuation by an operator, automated actuation, or other. In response to actuation of the filter actuator 549, an actuation signal from the circuit for closing filter pump switch 556 is generated, thereby closing switch 556 and causing current to be supplied to the filtering mechanism 550. The sensor 563 senses the current (or voltage) and generates a signal which is received by the control box input 572 and recorded by control box 562. This signal may be used to set an event count.

In some embodiments, the fryer 540 may further comprise a fry cycle mechanism 560. For example, in one embodiment, fry cycle mechanism 560 may comprise a standard electromechanical valve, or solenoid valve, found in commercial fryers, which regulates the flow of fryer oil to and from the oil reservoir. The solenoid valve may be opened/closed by running/stopping an electrical current through the valve.

Tracking of fry cycle events may be achieved in much the same way as tracking of filtration events. Thus, a sequence of operation of the fry cycle switch 564, sensor 568, and control box 562 for tracking fry cycle events is as follows. The fry cycle switch 564, sensor 568, and the control box 62 are in electronic communication with the fry cycle actuator 548 and fry cycle mechanism 560. In one embodiment, sensor 568 can include an amp clamp type ammeter, wrapped around a wire 581, to sense current flowing through the wire 581 to the fry cycle mechanism 560. This allows the system to know every time the fry cycle mechanism 560 is turned on. In one embodiment, sensor 568 can include a voltage detector, such as a capacitive coupling device. The voltage detector can be a non-contact voltage sensor that can be used to sense whether a voltage is present in wire 581 without physically tapping into the wire and thus whether a fry cycle event has begun or ended.

Actuation of the fry cycle actuator 548 initiates the sequence. Actuation may be manual actuation by an operator, automated actuation, or other. In response to actuation of the fry cycle actuator 548, an actuation signal from the circuit for closing the fry cycle switch 564 is generated, thereby closing the switch 564 and causing current to be supplied to the fry cycle mechanism 560. The sensor 568 senses the current (or voltage) and generates a signal which is received by control box input 570 and recorded by control box 562. This signal may be used to set an event count.

The sensors 563 and 568 of this example can be incorporated into any of the other examples described above for FIG. 2, and FIG. 3 and the example method of FIG. 4 and those discussions are incorporated herein by reference.

Although the present invention has been described with reference to exemplary embodiments, persons skilled in the art will recognize that changes may be made in form and detail without departing from the spirit and scope of the invention.

We claim:

1. A method for tracking operating data for commercial fryers comprising:
operating one or more commercial fryers, including activating an operational event for the one or more commercial fryers by sending a current through a wire to an operational member of the commercial fryer;
collecting information each time a different operational event is carried out in the commercial fryer by sensing whether the current is flowing through the wire or by sensing whether a voltage is present in the wire; and
communicating the information to a database.

2. The method of claim 1, wherein the operational event comprises a fry cycle event.

3. The method of claim 2, wherein the information includes a fry cycle event count.

4. The method of claim 1, wherein the operational event comprises a filtration event.

5. The method of claim 4, wherein the information includes a filtration event count.

6. The method of claim 1, wherein the information includes the duration of a fry cycle.

7. The method of claim 1 wherein the information includes the duration of a filtration event.

8. The method of claim 1, wherein a voltage detector is used to sense whether the voltage is present in the wire.

9. The method of claim 1, wherein operating reports are automatically generated on a periodic basis based on the information.

10. The method of claim 1, wherein operating reports are automatically generated after a predetermined number of operational events have occurred.

11. The method of claim 1, further comprising an amp clamp that is located around the wire and is not physically tapped into the wire and configured to sense whether the current is flowing through the wire.

12. A commercial fryer tracking system comprising:
one or more commercial fryers including an oil filtration mechanism and a fry cycle mechanism;
a first sensor operatively coupled to a wire supplying current to the oil filtration mechanism, the first sensor adapted to either sense a current through the wire or a voltage present in the wire, and deliver a signal indicative of an operational event of the oil filtration mechanism;
a second sensor operatively coupled to a wire supplying current to the fry cycle mechanism, the second sensor adapted to either sense a current through the wire or a voltage present in the wire, and deliver a signal indicative of an operational event of the fry cycle mechanism;
at least one control box, the control box being operatively associated with the first and second sensors such that control box receives operational information of the commercial fryer; and
a database for storing the operational information, the database being in communication with the control box such that the control box sends the operational information to the database.

13. The system of claim 12, wherein the operational information includes fry cycle events.

14. The system of claim 12, wherein the operational information includes filtration events.

15. The system of claim 12, wherein the operational information includes fry cycle events and filtration events.

16. The system of claim 12, wherein the central processor further includes software for generating operating reports, the operating reports being based on the operational information.

17. The system of claim 12, wherein the control box sends the operational information to the database remotely.

18. The system of claim 12, wherein the control box sends the operational information to the database in real time.

19. The system of claim 12, wherein the first and second sensors each include an amp clamp that is located around the wire and is not physically tapped into the wire.

20. The system of claim 12, wherein the first and second sensors each include a voltage detector that is not physically tapped into the wire.
